(19) United States
(12) Patent Application Publication
(10) Pub. No.: US 2026/0242639 A1
(43) Pub. Date: Aug. 20, 2026

(54) PROTECTIVE FILM FOR VEHICLE GLASS AND METHOD FOR MANUFACTURING THE SAME

(71) Applicant: STEK CO., LTD., Seoul (KR)

(72) Inventors: Chang Suk LEE, Cheonan-si (KR); Sang Tae KIM, Cheonan-si (KR); No Ah Oh, Cheonan-si (KR)

(73) Assignee: STEK CO., LTD., Seoul (KR)

(21) Appl. No.: 19/393,693

(22) Filed: Nov. 19, 2025

(30) Foreign Application Priority Data
Feb. 14, 2025 (KR) 10-2025-0019564

(51) Int. Cl. C09J 7/29; C09J 133/08

(52) U.S. Cl. CPC C09J 7/29; C09J 133/08; C09J 2203/354; C09J 2301/162; C09J 2301/408; C09J 2301/41; C09J 2301/414

(57) ABSTRACT

A protective film for vehicle glass includes: an adhesive layer; a substrate layer disposed on the adhesive layer and comprising a polyurethane acrylate oligomer, an acrylate monomer, and a photoinitiator; and a hard coating layer disposed on the substrate layer and including urethane acrylate, trifunctional acrylate, trifunctional methacrylate, methylbenzoyl formate, a photoinitiator, a fluorine additive, and a UV blocking agent.

### CROSS-REFERENCE TO RELATED APPLICATION

This application claims priority to and the benefit of Korean Patent Application No. 10-2025-0019564, filed on Feb. 14, 2025, the disclosure of which is incorporated herein by reference in its entirety.

### BACKGROUND

### 1. Field of the Invention

The present invention relates to a protective film for vehicle glass and a method for manufacturing the same, and more particularly, to a protective film for vehicle glass, which does not require a thermoforming process, and has improved crack resistance while having excellent stain resistance and scratch resistance, and a method for manufacturing the same.

### 2. Discussion of Related Art

Existing protective films applied to automobile windshields have effects of coating a substrate layer made of an elastic polyurethane (EPU) material with a urethane-based self-healing layer to protect the windshield from various external impacts including stone chips and of repairing scratches caused by wipers to maintain the surface condition.

However, such self-healing layers are relatively vulnerable to surface contamination by various external contaminants such as moisture and oil, and thus cause various problems such as an increase in haze.

Meanwhile, hard coatings are relatively prone to cracking, so that in order to compensate for this, a substrate layer made of materials such as PET, PMMA, and PC can be coated with the hard coatings, but it takes a lot of time to apply products made of these materials because the products require thermoforming.

Therefore, the inventors have developed a protective film for vehicle glass, which has improved resistance to cracks while securing excellent stain resistance, scratch resistance, slip property, and application property by applying a hard coating that has better stain resistance than a self-healing layer to prevent surface contamination by various contaminants.

### RELATED ART DOCUMENTS

### Patent Document

US Patent Publication No. 2007-0077420

### SUMMARY OF THE INVENTION

Thus, a problem to be solved by the present invention is to provide a protective film for vehicle glass, which does not require a thermoforming process, and has improved crack resistance while having excellent stain resistance and scratch resistance.

Another problem to be solved by the present invention is to provide a method for manufacturing the protective film for vehicle glass.

The problems of the present invention are not limited to the aforementioned technical problems, and other technical problems, which have not been mentioned, may be clearly understood by a person with ordinary skill in the art from the following description.

Specific details of other embodiments according to an embodiment of the present invention for solving the above problems are included in the detailed description.

### BRIEF DESCRIPTION OF THE DRAWINGS

FIG. 1 is a cross-sectional view showing a stacked structure of a protective film for vehicle glass according to an embodiment of the present invention.

FIG. 2 is a set of photographs confirming the stain resistance of a protective film for vehicle glass according to the experimental example of the present invention.

FIG. 3 is a photograph of the hena and pens used in the experimental example of the present invention.

FIG. 4 is a set of photographs confirming the scratch resistance of a protective film for vehicle glass according to the experimental example of the present invention.

FIG. 5 is a photograph of the rubbing test and steel wool (#0000) apparatus used in the experimental example of the present invention.

FIG. 6 is a photograph of the 94i-ll friction coefficient tester manufactured by Heidon used in the experimental example of the present invention.

FIG. 7 is a set of photographs showing the measurement of crack generation in a protective film for vehicle glass according to the experimental example of the present invention.

FIG. 8 is a photograph of the Xenon Weather Ometer_Ci4400 weathering test apparatus used in the experimental example of the present invention.

FIG. 9 is a photograph of the wireless bar coater used in the experimental example of the present invention.

### DETAILED DESCRIPTION OF EXEMPLARY EMBODIMENTS

The benefits and features of the present invention, and the methods of achieving the benefits and features will become apparent with reference to embodiments to be described below in detail. However, the present invention is not limited to the embodiments to be disclosed below and may be implemented in various other forms, and the embodiments are only provided for rendering the disclosure of the present invention complete and for fully representing the scope of the invention to a person with ordinary skill in the technical field to which the present invention pertains, and the present invention will be defined only by the scope of the claims.

The terms used in the present specification are used merely to describe embodiments, and are not intended to limit the present invention. In the present specification, the ‘and/or’ includes each and all combinations of one or more of the items mentioned. Further, the singular form includes the plural forms unless specifically stated in a phrase. The terms ‘comprises’ and/or ‘comprising’ used in the specification do not exclude the presence or addition of one or more other constituent elements in addition to the referenced constituent elements. The numerical range indicated by using ‘-’ or ‘to’ indicates a numerical range including values described before and after it as a lower limit and an upper limit, respectively, unless otherwise stated. ‘About’ or ‘approximately’ means a value or numerical range within 20% of the value or numerical range described thereafter.

In describing the constituent elements of the examples of the present invention, terms such as first, second, A, B, (a), and (b) may be used. These terms are merely for distinguishing one constituent element from another, and the nature, turn, or order of the corresponding constituent element is not limited by the term.

Since the size and thickness of each component shown in the drawings may be arbitrarily shown for the convenience of explanation, the present invention is not necessarily limited to those shown in the drawings. In the drawings, in order to clearly express several layers and regions, their thickness may be enlarged. Moreover, in the drawings, the thicknesses of some layers and regions may be exaggerated for convenience of explanation.

A case where a part such as a layer, a film, a region, and a plate is present “under” or “at a lower portion of” another part includes not only a case where the part is present “immediately under” another part, but also a case where still another part is present therebetween, unless otherwise specified. In addition, a case of being ‘above’ or ‘on’ a reference part means being located above or below the reference part, and does not necessarily mean being located ‘above’ or ‘on’ in the opposite direction of gravity.

The description ‘on a plane’ means that a target part is viewed from above, and the description ‘on a cross section’ means that the target part is cut vertically and viewed from the side.

Unless otherwise defined, all the terms (including technical and scientific terms) used in the present specification will be able to be used as a meaning which may be commonly understood to a person with ordinary skill in the art to which the present invention pertains. In addition, the terms defined in generally used dictionaries are not to be interpreted ideally or excessively unless clearly and specifically defined.

Moreover, in describing the embodiments of the present invention, when it is determined that the specific description of relevant known configurations or functions obstructs the understanding for the embodiments of the present invention, the detailed description thereof will be omitted.

Hereinafter, embodiments of the present invention will be described in detail with reference to the accompanying drawings.

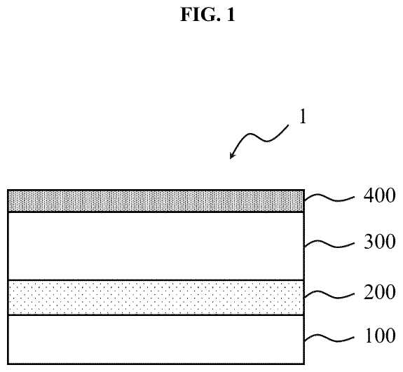

FIG. 1 is a cross-sectional view showing a stacked structure of a protective film for vehicle glass according to an embodiment of the present invention.

Referring to FIG. 1, the protective film for vehicle glass 1 includes an adhesive layer 200, a substrate layer 300 disposed on the adhesive layer 200, and a hard coating layer 400 disposed on the substrate layer 300.

In addition, the protective film for vehicle glass 1 may further include a release film 100 disposed under the adhesive layer 200.

Vehicle glass may particularly refer to an automobile windshield, but the embodiments of the present invention are not limited thereto, may refer to all glass applied to various types of vehicles and glass having similar characteristics to those required for vehicle glass, and are not limited to that type.

### Substrate Layer

The substrate layer 300 may include a polyurethane acrylate oligomer, an acrylate monomer, and a photoinitiator.

Conventional protective films for vehicle glass may implement high strength and hardness because plastic films including PET and the like are used as a substrate layer, but when a protective film having such a substrate layer is attached to the curved surface of an automobile windshield, there is a problem in that it takes a long time for application because a thermoforming process is necessarily required.

The protective film of the present invention may implement optimal strength, hardness, and elasticity capable of attaching a protective film for vehicle glass, which includes the substrate layer, to a curved surface such as an automobile windshield without a thermoforming process, and of securing improved impact absorption performance while securing the impact resistance, strength, hardness, ductility, and the like required for a protective film for vehicle glass.

The polyurethane acrylate oligomer may impart flexibility to the substrate layer, and the photoinitiator may impart hardness to the substrate layer. Such a substrate layer may have lower strength and/or hardness than a PET film. The PET film may be a film having a tensile strength of 160 MPa or more and/or a hardness of 2 to 3 H. However, it is not limited thereto.

Having low strength and hardness means that the film is deformed relatively easily even at room temperature at which heat is not applied, and when a protective film having low strength and hardness is attached to the curved surface of an automobile windshield, a thermoforming process may not be required. Accordingly, application property may be improved by reducing the application time.

The substrate layer may include 25 to 40 parts by weight of a polyurethane acrylate oligomer, 50 to 70 parts by weight of an acrylate monomer, and 0.1 to 5 parts by weight of a photoinitiator. When the composition of the substrate layer is within the above range, a protective film may be applied to the curved surface of an automobile windshield without a thermoforming process by implementing optimal strength, hardness, and elasticity.

The thickness of the substrate layer may be 100 to 250 μm, specifically 120 to 220 μm, and more specifically 150 to 200 μm. When the thickness of the substrate layer is greater than the above range, the thickness deviation is increased, and poor appearance may occur. When the thickness is less than the above range, impact resistance may deteriorate.

### Hard Coating Layer

The hard coating layer 400 may include urethane acrylate, trifunctional acrylate, trifunctional methacrylate, methylbenzoyl formate, a photoinitiator, a fluorine additive, and a UV blocking agent. The trifunctional acrylate and trifunctional methacrylate may refer to those known in the related art, but the embodiments of the present invention are not limited thereto.

Conventional protective films for vehicle glass include a self-healing layer on the upper surface of the substrate layer, but these self-healing layers are vulnerable to surface contamination by various external contaminants such as moisture and oil, and thus cause various problems such as an increase in haze.

The protective film for vehicle glass of the present invention has excellent application property, scratch resistance, and slip property while preventing surface contamination by various contaminants by applying a hard coating

Meanwhile, hard coatings are relatively prone to cracking, so that to compensate for this, a substrate layer made of a material such as PET, PMMA, and PC can be coated with the hard coating, but it takes a lot of time to apply products made of these materials because the products require thermoforming.

Since the protective film for vehicle glass of the present invention does not require a thermoforming process using a substrate layer made of an elastic polyurethane (EPU) material, application property is improved, and crack resistance is enhanced by designing the composition, content, and thickness of the hard coating layer within the optimal ranges.

In an embodiment, the photoinitiator may include one or more of hydroxycyclohexyl phenyl ketone and bis(2,4,6-trimethylbenzoyl)phenylphosphine oxide, the fluorine additive may include polytetrafluoroethylene (poly(1,1,2,2-tetrafluoroethylene)), and the UV blocking agent may include one or more of 2-hydroxyphenyl-s-triazine and bis(2,2,6,6-tetramethyl-4-piperidyl) sebacate. However, the embodiments of the present invention are not limited thereto.

The hard coating layer may include 5 to 20 parts by weight of urethane acrylate, 3 to 15 parts by weight of trifunctional acrylate, 2 to 5 parts by weight of trifunctional methacrylate, 0.5 to 1 part by weight of methylbenzoyl formate, 0.2 to 1 part by weight of a photoinitiator, 0.5 to 1 part by weight of a fluorine additive, and 1 to 3 parts by weight of a UV blocking agent. When the composition of the hard coating layer is within the above range, the hard coating layer has excellent crack resistance while securing excellent stain resistance and scratch resistance compared to the self-healing layer. In particular, when the content of the photoinitiator exceeds the above range, scratch resistance may deteriorate and the film may become susceptible to cracks, and when the content of the UV blocking agent is less than the above range, the film may become susceptible to cracks.

The thickness of the hard coating layer may be 1 to 8 μm, specifically 2 to 7 μm, and more specifically 3 to 6 μm. When the thickness of the hard coating layer is greater than the above range, the product may curl significantly and may be susceptible to cracks caused by stone chips, and the like during application and handling. When the thickness of the hard coating layer is thinner than the above range, scratch resistance may deteriorate due to wipers and the like.

### Adhesive Layer

The adhesive layer 200 may include an acrylic copolymer, a curing agent, and a UV blocking agent. The curing agent may specifically be an epoxy curing agent or a chelate curing agent.

In conventional PET products, methods capable of improving attachment properties between a substrate layer and each layer disposed on the upper surface and lower surface of the substrate layer are used by performing a surface treatment process such as corona treatment and primer treatment on the surface of the substrate layer, but surface treatments such as corona treatment and primer treatment are not common for substrate layers made of elastic materials, which includes an additional process such as surface treatment, thereby increasing the unit price of a product.

Therefore, when a material with excellent bonding strength (adhesion) between a substrate and a coating layer is applied, the transfer phenomenon may be prevented without increasing the unit price of a product, and the protective film for vehicle glass of the present invention may reduce the unit price by applying an adhesive layer with a composition and thickness capable of implementing high adhesion strength between the adhesive layer and the substrate layer without a separate surface treatment process.

In addition, the protective film for vehicle glass of the present invention may prevent the transfer phenomenon in which an adhesive is transferred to the glass when the protective film for vehicle glass is removed as attachment properties between the adhesive layer and the substrate layer are improved.

The adhesive layer may include 70 to 90 parts by weight of an acrylic copolymer, 0.1 to 5 parts by weight of an epoxy curing agent or a chelate curing agent, and 1 to 5 parts by weight of a UV blocking agent. When the composition of the adhesive layer is within the above range, the attachment strength and adhesion strength between the adhesive layer and the substrate layer are appropriately high, so that a separate surface treatment process is not required, and it is possible to prevent the transfer phenomenon in which the adhesive is transferred to the glass when the protective film for vehicle glass is removed.

The thickness of the adhesive layer may be 5 to 20 μm, specifically 7 to 15 μm. When the thickness of the adhesive layer is within the above range, the attachment strength and adhesion strength between the adhesive layer and the substrate layer are appropriately high, so that a separate surface treatment process is not required, and it is possible to prevent the transfer phenomenon in which an adhesive is transferred to the glass when the protective film for vehicle glass is removed.

### Release Film

The release film 100 may protect the adhesive layer until the protective film for vehicle glass of the present invention is attached to the vehicle glass. The release film may be a silicone release film.

It is preferred that the release film needs to be easily removed by an application worker during application of the protective film for vehicle glass, and has an appropriate peel strength to prevent lifting (tunneling) between the release film and the adhesive layer. In an embodiment, the release film may include any common release film that has an appropriate peel strength and has difficulty in increasing its peel strength over time while being attached to the adhesive layer.

The thickness of the release film may be 20 to 150 μm, specifically 50 to 75 μm. However, the embodiments of the present invention are not limited thereto.

A method for manufacturing a protective film for vehicle glass according to an embodiment of the present invention includes (a) forming an adhesive layer 200 on the lower surface of a substrate layer 300 and (b) forming a hard coating layer 400 on the upper surface of the substrate layer 300.

The forming of the hard coating layer may be a step of coating the upper surface of the substrate layer with a composition including urethane acrylate, trifunctional acrylate, trifunctional methacrylate, methylbenzoyl formate, a photoinitiator, a fluorine additive, and a UV blocking agent, and then curing the composition by irradiating the substrate layer with UV rays with a light intensity of 200 to 400 mJ.

In addition, the method may further include laminating a release film 100 on the lower surface of the adhesive layer 200. A description of each layer will be omitted because it has been described above.

Hereinafter, the present invention will be described through Experimental Examples, but it is obvious that the effects of the present invention are not limited by the following Experimental Examples.

### PREPARATION EXAMPLES

### Example 1

A substrate layer including 30 parts by weight of a polyurethane acrylate oligomer, 60 parts by weight of an acrylate monomer, and 2 parts by weight of a photoinitiator was formed to a thickness of 150 μm. An adhesive layer including 80 parts by weight of an acrylic copolymer, 2 parts by weight of an epoxy curing agent, and 2 parts by weight of a UV blocking agent was formed to a thickness of 10 μm as a primary coating on the lower surface of the substrate layer. A hard coating layer including 10 parts by weight of urethane acrylate, 8 parts by weight of trifunctional acrylate, 3 parts by weight of trifunctional methacrylate, 0.8 parts by weight of methylbenzoyl formate, 0.5 parts by weight of a photoinitiator, 0.8 parts by weight of a fluorine additive, and 2 parts by weight of a UV blocking agent was cured by UV rays with a light intensity of 200 to 400 mJ and formed to a thickness of 5 μm as a secondary coating on the upper surface of the substrate layer, thereby manufacturing a protective film for vehicle glass.

### Comparative Example 1

A protective film for vehicle glass was manufactured in the same manner as in Example 1, except that a self-healing layer including 100 parts by weight of a urethane resin and 40 parts by weight of an isocyanate curing agent was formed to a thickness of 20 μm as a secondary coating on the upper surface of the substrate layer instead of the hard coating layer.

### Comparative Example 2

A substrate layer including 100 parts by weight of a transparent PET film was formed to a thickness of 35 μm. The same adhesive layer as in Example 1 was formed to the same thickness as in Example 1 as a primary coating on the lower surface of the substrate layer to prepare a primary semi-finished product.

A substrate layer including 100 parts by weight of a transparent PET film was formed to a thickness of 60 μm. The same hard coating layer as in Example 1 was formed as a primary coating on the upper surface of the substrate layer by curing with UV rays with the same light intensity as in Example 1 so as to have the same thickness as in Example 1. An adhesive layer including 80 parts by weight of an acrylic copolymer and 2 parts by weight of an epoxy curing agent was formed to a thickness of 10 μm on the lower surface of the substrate layer to prepare a secondary semi-finished product.

The primary and secondary semi-finished products were laminated to manufacture a PET-type protective film for vehicle glass.

### Comparative Example 3

A protective film for vehicle glass was manufactured in the same manner as in Example 1, except that the hard coating layer was formed to a thickness of 10 μm on the upper surface of the substrate layer.

### Comparative Example 4

A protective film for vehicle glass was manufactured in the same manner as in Example 1, except that the hard coating layer on the upper surface of the substrate layer included 2 parts by weight of a photoinitiator.

### Comparative Example 5

A protective film for vehicle glass was manufactured in the same manner as in Example 1, except that the hard coating layer on the upper surface of the substrate layer did not include a UV blocking agent.

### Experimental Example

The application property, stain resistance, scratch resistance, slip property and crack resistance of the protective film for vehicle glass of the present invention were evaluated.

### Application Property

The following Table 1 shows the results of measuring the time taken to apply the protective films for vehicle glass of the examples and comparative examples to an automobile windshield.

TABLE 1

| Classification | Application completion time |
|---|---|
| Example 1 | 20 minutes on average |
| Comparative Example 1 | 20 minutes on average |
| Comparative Example 2 | 100 minutes on average |
| Comparative Example 3 | 20 minutes on average |
| Comparative Example 4 | 20 minutes on average |
| Comparative Example 5 | 20 minutes on average |

As shown in Table 1 above, it took 20 minutes on average to attach Example 1 to the curved surface of the automobile windshield, whereas it took 100 minutes on average for Comparative Example 2. That is, it can be seen that the protective film for vehicle glass of the present invention can be applied within a relatively short time because thermoforming is not required, unlike the PET-type Comparative Example 2.

### Stain Resistance

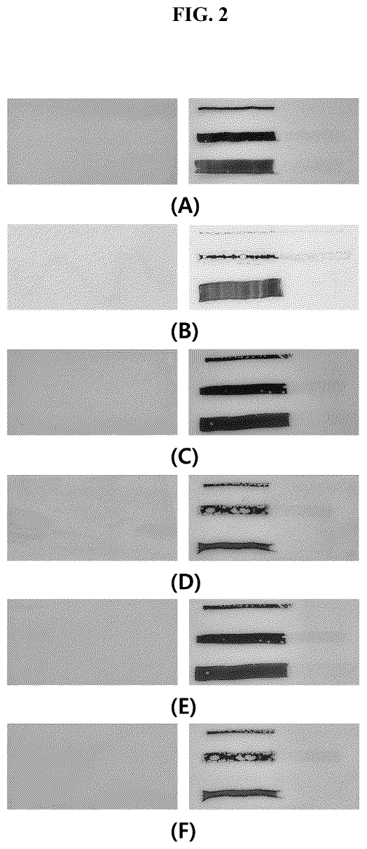

Table 2 and FIG. 2 shows the results and a set of photographs confirming the stain resistance of a protective film for vehicle glass according to the experimental example of the present invention, respectively. In FIG. 2, (A) to (F) refer to Example 1 and Comparative Examples 2 to 5, respectively.

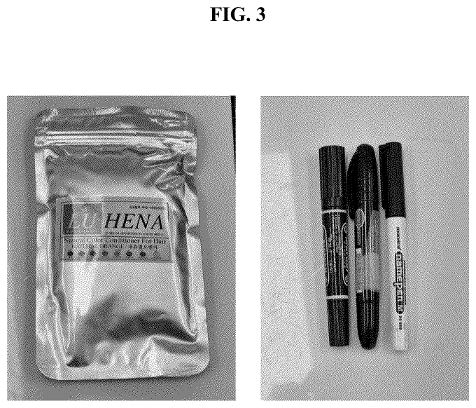

Stain resistance was confirmed using henna and pens as shown in FIG. 3. For the henna, 1 g of henna was dissolved in 7.5 g of water, about 3 ml of the resulting solution was applied to the surface of a protective film for vehicle glass, the protective film was left to stand in an oven at 60° C. for 1 hour, and then the surface was washed with a wet tissue to confirm the degree of residue remaining on the surface. For the pen, various permanent markers which can be used in daily life were used to draw a straight line on the surface of a protective film for vehicle glass, and only a half of the surface was washed with a board to confirm the degree of residue remaining on the surface.

TABLE 2

| | Surface contamination residue condition | |
|---|---|---|
| Classification | Henna Test | Pen Test |
| Example 1 | No residue | Weak residue present |
| Comparative Example 1 | Weak residue present | Residue present |
| Comparative Example 2 | No residue | Weak residue present |
| Comparative Example 3 | No residue | Weak residue present |
| Comparative Example 4 | No residue | Weak residue present |
| Comparative Example 5 | No residue | Weak residue present |

As shown in Table 2 and FIG. 2, Example 1 left no residue in the henna test and only a weak residue in the pen test, whereas Comparative Example 1 left all residue in both the henna test and the pen test. That is, it can be seen that the protective film for vehicle glass of the present invention has excellent stain resistance, unlike Comparative Example 1 which has a self-healing layer.

### Scratch Resistance

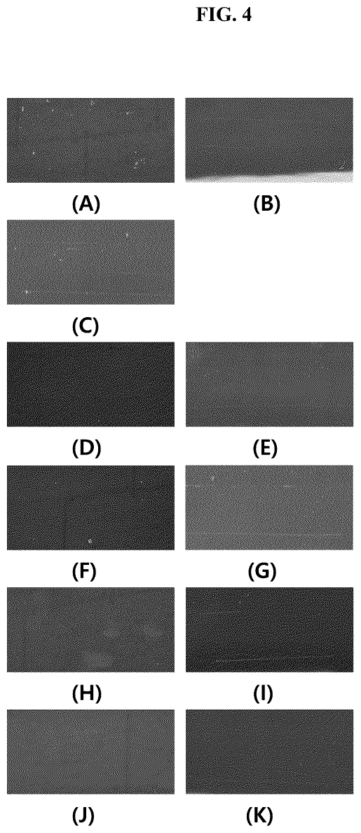

Table 3 and FIG. 4 show the results and a set of photographs confirming the scratch resistance of a protective film for vehicle glass according to the experimental example of the present invention, respectively. In FIG. 4, (A) and (B) refer to Example 1, (C) refers to Comparative Example 1, (D) and (E) refer to Comparative Example 2, (F) and (G) refer to Comparative Example 3, (H) and (I) refer to Comparative Example 4, and (J) and (K) refer to Comparative Example 5.

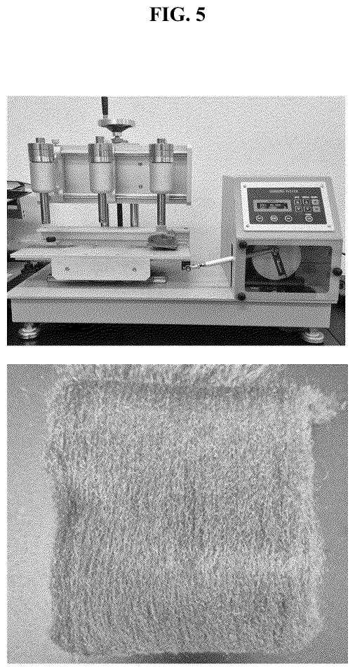

The scratch resistance characteristics of the protective film for vehicle glass were confirmed using the rubbing test and Steel Wool (#0000) as shown in FIG. 5. The rubbing test apparatus confirmed the degree of scratches remaining on the surface of the protective film for vehicle glass by placing a steel wool with a load of 750 g on the surface and allowing the protective film to reciprocate at 80 rpm. In the case of the self-healing layer of Comparative Example 1, the scratches on the surface were thermally healed using a heat gun and then confirmed.

TABLE 3

| Classification | Surface scratch condition |
|---|---|
| Example 1 | 1,000 reciprocations: No |
| | generation of scratches |
| | 3,000 reciprocations: |
| | Generation of fine scratches |
| Comparative Example 1 | 1,000 reciprocations: |
| | Generation of scratches |
| Comparative Example 2 | 1,000 reciprocations: No |
| | generation of scratches |
| | 3,000 reciprocations: |
| | Generation of fine scratches |
| Comparative Example 3 | 1,000 reciprocations: No |
| | generation of scratches |
| | 3,000 reciprocations: |
| | Generation of fine scratches |
| Comparative Example 4 | 1,000 reciprocations: No |
| | generation of scratches |
| | 2,000 reciprocations: |
| | Generation of fine scratches |
| Comparative Example 5 | 1,000 reciprocations: No |
| | generation of scratches |
| | 3,000 reciprocations: |
| | Generation of fine scratches |

As shown in Table 3 and FIG. 4, in Example 1, no scratches were generated in a 1,000 reciprocating test, and only fine scratches were also generated in a 3,000 reciprocating test. In contrast, in Comparative Example 1, scratches were also generated in the 1,000 reciprocating test, and in Comparative Example 4, scratches began to be generated in a 2,000 reciprocating test.

That is, it can be seen that the protective film for vehicle glass of the present invention has excellent scratch resistance, unlike Comparative Example 1 having a self-healing layer and Comparative Example 4 using an excessive amount of a photoinitiator.

### Slip Property

Table 4 shows the results of measuring the coefficient of friction of a protective film for vehicle glass according to the experimental example of the present invention.

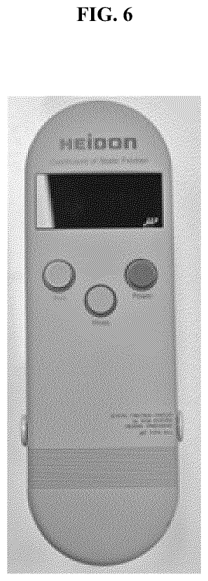

A 94i-ll friction coefficient tester manufactured by Heidon, as shown in FIG. 6, was placed on the surface of a protective film for vehicle glass, and the friction force between the slider of the tester and the surface was measured. The lower the measured coefficient of friction, the better the slip property, so that the generation of scratches was reduced.

TABLE 4

| | Measured value of |
|---|---|
| Classification | friction of coefficient |
| Example 1 | 0.06 |
| Comparative Example 1 | 0.73 |
| Comparative Example 2 | 0.09 |
| Comparative Example 3 | 0.08 |
| Comparative Example 4 | 0.08 |
| Comparative Example 5 | 0.07 |

As shown in Table 4, Example 1 had the lowest measured coefficient of friction at 0.06, whereas Comparative Example 1 had the highest measured coefficient of friction at 0.73. That is, it can be seen that the protective film for vehicle glass of the present invention has excellent slip property, and thus causes a smaller amount of scratches to be generated, unlike Comparative Example 1 having a self-healing layer.

### Crack Resistance

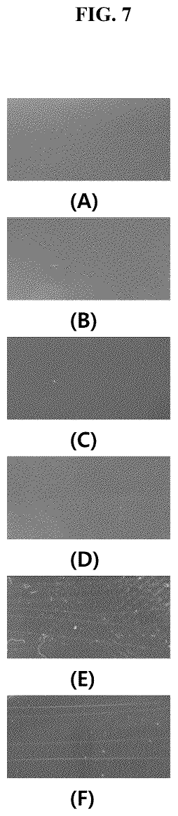

Table 5 and FIG. 7 show the results and a set of photographs measuring the generation of cracks in a protective film for vehicle glass according to the experimental example of the present invention, respectively. In FIG. 7, (A) to (F) refer to Example 1 and Comparative Examples 2 to 5, respectively.

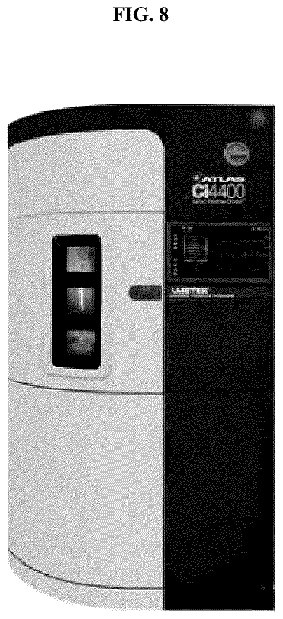

A protective film for vehicle glass was placed inside the Xenon Weather Ometer_Ci4400 weathering test apparatus as shown in FIG. 8 and exposed to a xenon lamp (ultraviolet rays) located in the center of the interior for 2,000 hours, and then the crack characteristics of the hard coating layer or self-healing layer were confirmed depending on whether or not a UV blocking agent was added.

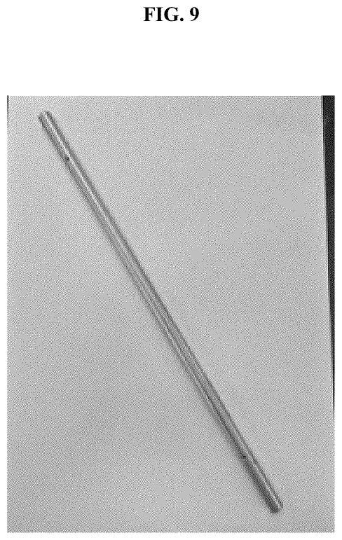

The protective film for an automobile windshield placed in the weathering test apparatus was wrapped around a wireless bar coater, which is a steel rod with a radius of curvature of ½″ radius and a diameter of about 12.7 mm, as shown in FIG. 9, such that the hard coating layer or self-healing layer was faced inward, and the protective film was left to stand for 6 hours, and then it was confirmed whether cracks had been generated on the surface of the hard coating or self-healing layer.

TABLE 5

| Classification | Presence or absence of cracks |
|---|---|
| Example 1 | No generation of cracks |
| Comparative Example 1 | No generation of cracks |
| Comparative Example 2 | No generation of cracks |
| Comparative Example 3 | Generation of cracks |
| Comparative Example 4 | Generation of cracks |
| Comparative Example 5 | Generation of cracks |

As shown in Table 5 and FIG. 7, no cracks were generated in the hard coating layer in Example 1, whereas cracks were generated in the hard coating layer in Comparative Examples 3 to 5. That is, it can be seen that the protective film for vehicle glass of the present invention has excellent resistance to cracks, unlike Comparative Example 3, which was excessively thick, Comparative Example 4 in which an excessive amount of a photoinitiator was used, and Comparative Example 5 in which a UV blocking agent was not used.

The protective film for vehicle glass according to the embodiments of the present invention does not require a thermoforming process, and has improved crack resistance while having excellent stain resistance and scratch resistance.

The effects according to the embodiments of the present invention are not limited to the contents exemplified above, and more various effects are included in the present specification.

As described above, although the present invention is mainly described with reference to the embodiments of the present invention, this is merely an example and does not limit the present invention, and it will be appreciated that a person with ordinary skill in the art to which the present invention pertains can make various modifications and applications which are not exemplified above within a range not departing from the essential characteristics of the embodiments of the present invention. For example, each constituent element specifically shown in the embodiments of the present invention can be modified and implemented. And differences related to these modifications and applications should be construed as being included in the scope of the present invention defined in the appended claims.

What is claimed is:

1. A protective film for vehicle glass comprising:
an adhesive layer;
a substrate layer disposed on the adhesive layer and comprising a polyurethane acrylate oligomer, an acrylate monomer, and a photoinitiator; and
a hard coating layer disposed on the substrate layer and comprising urethane acrylate, trifunctional acrylate, trifunctional methacrylate, methylbenzoyl formate, a photoinitiator, a fluorine additive, and a UV blocking agent.

2. The protective film of claim 1, wherein the hard coating layer comprises:
5 to 20 parts by weight of urethane acrylate;
3 to 15 parts by weight of trifunctional acrylate;
2 to 5 parts by weight of trifunctional methacrylate;
0.5 to 1 part by weight of methylbenzoyl formate;
0.2 to 1 part by weight of a photoinitiator;
0.5 to 1 part by weight of a fluorine additive; and
1 to 3 parts by weight of a UV blocking agent.

3. The protective film of claim 1, wherein the hard coating layer has a thickness of 1 to 8 μm.

4. The protective film of claim 1, wherein the substrate layer has a thickness of 100 to 250 μm.

5. The protective film of claim 1, wherein the substrate layer comprises:
25 to 40 parts by weight of a polyurethane acrylate oligomer;
50 to 70 parts by weight of an acrylate monomer; and
0.1 to 5 parts by weight of a photoinitiator.

6. The protective film of claim 1, wherein the adhesive layer comprises:
70 to 90 parts by weight of an acrylic copolymer;
0.1 to 5 parts by weight of an epoxy curing agent or a chelate curing agent; and
1 to 5 parts by weight of a UV blocking agent.

7. The protective film of claim 1, wherein the vehicle glass is an automobile windshield.
